(19) United States
(12) Patent Application Publication
(10) Pub. No.: US 2013/0166622 A1
(43) Pub. Date: Jun. 27, 2013

(54) Using Mobile Device Location Data with Remote Resources

(71) Applicant: Maharajan Arunachalam, Bangalore (IN)

(72) Inventor: Maharajan Arunachalam, Bangalore (IN)

(73) Assignee: CITRIX SYSTEMS, INC, Ft. Lauderdale, FL (US)

(21) Appl. No.: 13/466,486

(22) Filed: May 8, 2012

Related U.S. Application Data
(60) Provisional application No. 61/580,551, filed on Dec. 27, 2011.

(51) Int. Cl. G06F 15/16

(52) U.S. Cl. 709/202; 709/203

(57) ABSTRACT

A mobile computing device may use location data to select one or more servers with which to connect. The location data may be communicated to the one or more servers and used by the one or more servers to tailor virtual applications to the location of the mobile computing device.

### FIELD

The present disclosure relates generally to mobile devices that may display applications executing on a remote server. The mobile devices may connect to remote servers based on location information, and the mobile devices may provide location information to remote servers.

### BACKGROUND

Users of mobile devices, such as smart phones or tablets, may desire to view applications that execute on a remote server instead of on the mobile device itself. However, these users typically encounter problems using applications that execute remotely, especially if the applications utilize Global Positioning System (GPS) data. Further, users desiring to view applications that execute on a remote server often have difficulty identifying a remote server with which to interact.

### CROSS REFERENCE TO RELATED APPLICATIONS

This application claims priority to U.S. Provisional Patent Application Ser. No. 61/580,551, which was filed Dec. 27, 2011, and which is incorporated herein by reference for all purposes.

### SUMMARY

Systems and methods for using a mobile device's location data with remote resources are described. The remote resources may run virtualized applications that display on the mobile device.

According to a first aspect, a client agent on the mobile device may select a set of one or more server farms to connect to using location data of the mobile device, such as GPS data. The client agent may select which server farm(s) to connect to based on location data of the mobile device. For example, the server farm located nearest to the mobile device may be selected. The client agent may also consider other factors, such as which user applications are available at the server farm, the default localization of the servers in the server farm, etc. The factors to be considered by the client agent when selecting a server farm may be specified in whole or in part by a user of the mobile device.

According of another aspect, a client agent on a mobile device may connect to one or more of the identified server farms automatically, thereby allowing a user to connect to a geographically-local server farm without having to identify a server farm on each connection attempt. Optionally, the client agent may allow a user to choose between several server farms at each connection attempt instead of selecting a server farm automatically

According to a further aspect, a client agent of a mobile device may pass the location data of the mobile device to a remote server. The location data of the mobile device may be used by applications running on the remote server instead of the location data of the remote server itself

According to a still further aspect, the client agent of a mobile device may establish a presentation layer protocol connection with a server of a server farm. The client agent may transmit data from the mobile device to the server of the server farm via the presentation layer protocol connection, including location data.

According to an additional aspect, the client agent may establish a connection with multiple servers of a single server farm and/or with multiple servers of multiple server farms. Connections with additional serves may be created responsive to a failed connection attempt with a first server. The client agent may also re-establish failed connections.

0 The details of various embodiments of the methods and systems described herein are set forth in the accompanying drawings and the description below.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A illustrates an example computing environment that may be used in accordance with aspects of the disclosure.

FIG. 1B and FIG. 1C illustrate examples of computing devices.

FIG. 2 illustrates a system that includes a mobile computing device and several server farms to which the mobile computing device may connect.

FIG. 3 illustrates a method for establishing a connection to a server responsive to geographic location data.

The features and advantages of the methods and systems described herein will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

The detailed description is divided into two sections. Section A describes an example of an environment in which various aspects of the disclosure may be implemented. Section B describes systems in which various aspects of the disclosure may be implemented in more detail and also describes various methods by which various aspects of the disclosure may be implemented.

### Section A: Network and Computing Environment

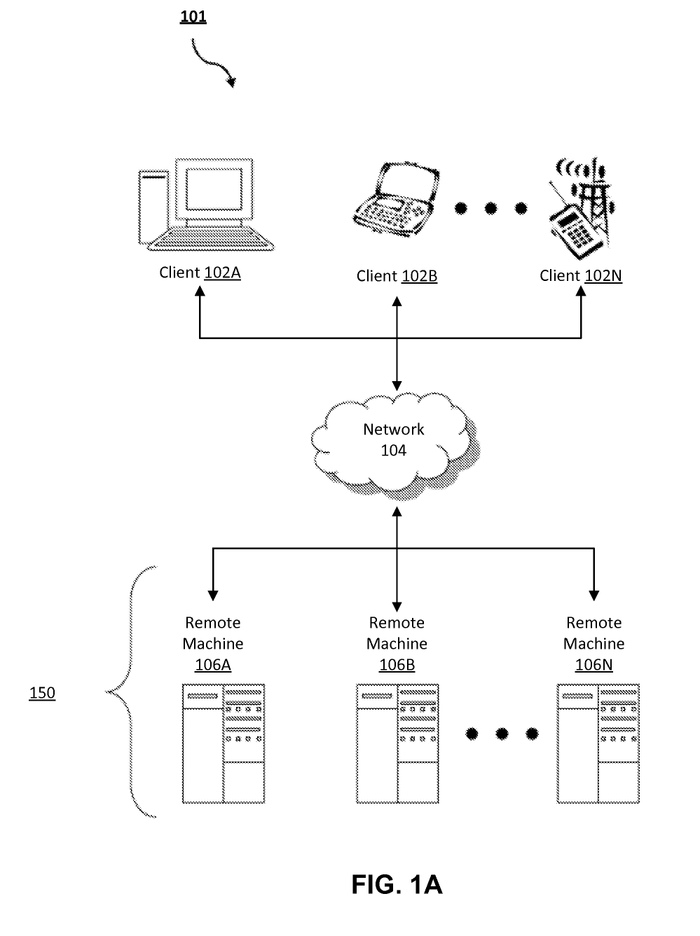

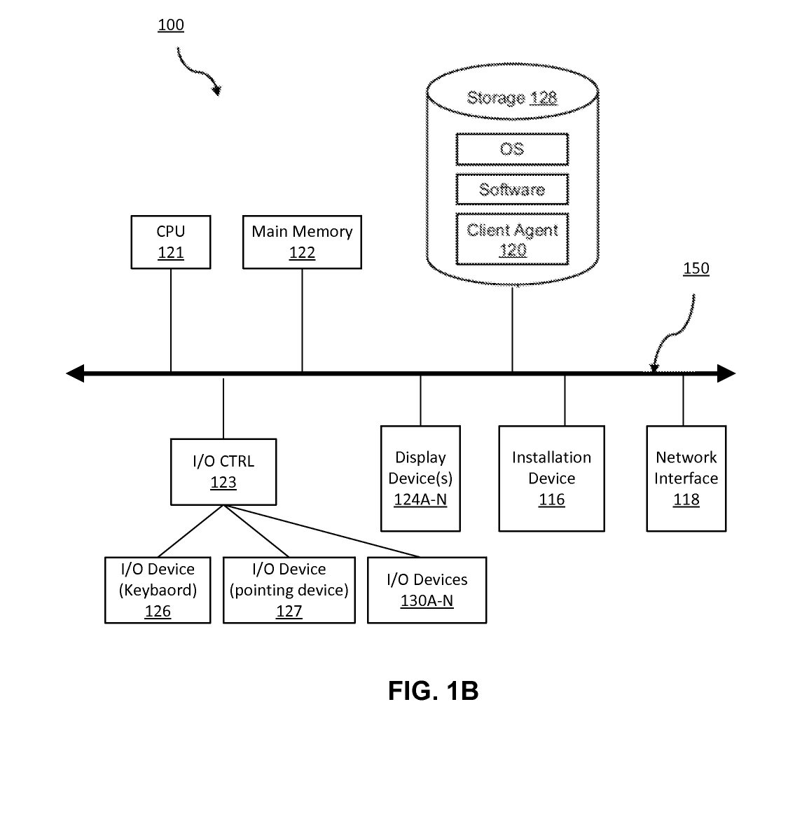

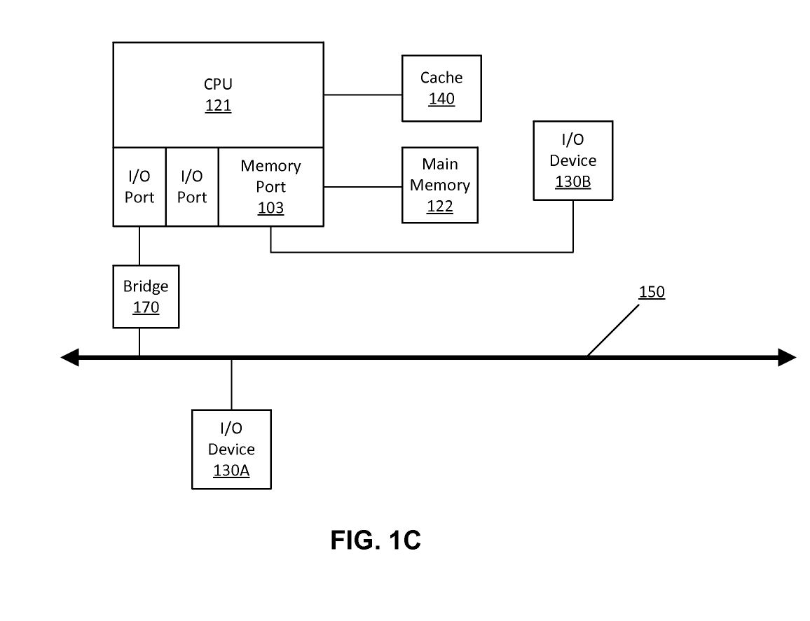

FIG. 1A illustrates one example of a computing environment 101 that includes one or more client machines 102A-102N (generally referred to herein as “client machine(s) 102”) that are in communication with one or more servers 106A-106N (generally referred to herein as “server(s) 106”). Installed in between the client machine(s) 102 and server(s) 106 is a network 104.

In one embodiment, the computing environment 101 may include an appliance installed between the server(s) 106 and client machine(s) 102. This appliance may manage client/server connections, and in some cases may load balance client connections amongst a plurality of servers.

The client machine(s) 102 may, in some embodiments, be referred to as a single client machine 102 or a single group of client machines 102, while server(s) 106 may be referred to as a single server 106 or a single group of servers 106. A single client machine 102 may communicate with more than one server 106, a single server 106 may communicate with more than one client machine 102, and a single client machine 102 may communicate with a single server 106.

A client machine 102 may, in some embodiments, be referenced by any one of the following terms: client machine(s) 102; client(s); client computer(s); client device(s); client computing device(s); local machine; remote machine; client node(s); endpoint(s); or endpoint node(s). The server 106, in some embodiments, may be referenced by any one of the following terms: server(s), local machine; remote machine; server farm(s), or host computing device(s).

In one embodiment, the client machine 102 may be a virtual machine. The virtual machine may be managed by a hypervisor such as the Xen hypervisor, developed sold by Citrix Systems, Inc., Hyper-V, developed and sold by Microsoft Corp., ESX, developed and sold by EMC, or any other hypervisor.

The client machine 102 may in some embodiments execute, operate, or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications, such as a soft IP telephone; an application for streaming video and/or audio; an application for facilitating real-time-data communications; a HTTP client; a FTP client; an Oscar client; a Telnet client; or any other set of executable instructions. Still other embodiments include a client device 102 that displays application output generated by an application remotely executing on a server 106 or other remotely located machine. In these embodiments, the client device 102 may display the application output in an application window, a browser, or other output window. Client device 102 may also display a desktop and/or generate a desktop. A desktop refers to a graphical environment or space in which one or more applications may be hosted and/or executed. A desktop may include a graphical shell providing a user interface for an instance of an operating system in which local and/or remote applications may be integrated. Applications, as used herein, are programs that execute after an instance of an operating system (and, optionally, also the desktop) has been loaded. Each instance of the operating system may be physical (e.g., one operating system per device) or virtual (e.g., many instances of an OS running on a single device). Each application may be executed on a local device, or executed on a remotely located device (e.g., remoted).

The server 106, in some embodiments, executes a remote presentation client or other client or program that uses a thin-client or remote-display protocol to capture display output generated by an application and/or desktop executing on a server 106 and transmits the application and/or desktop display output to a remote client 102. The thin-client or remote-display protocol may be any one of the following protocols: the Independent Computing Architecture (ICA) protocol manufactured by Citrix Systems, Inc. of Ft. Lauderdale, Fla.; or the Remote Desktop Protocol (RDP) manufactured by the Microsoft Corporation of Redmond, Wash..

The computing environment may include more than one server 106A-106N such that the servers 106A-106N are logically grouped together into a server farm 150. The server farm 150 may include servers 106 that are geographically dispersed and logically grouped together in a server farm 150, or servers 106 that are located proximate to each other and logically grouped together in a server farm 150. Geographically dispersed servers 106A-106N within a server farm 150 may, in some embodiments, communicate using a WAN, MAN, or LAN, where different geographic regions may be characterized as: different continents; different regions of a continent; different countries; different states; different cities; different campuses; different rooms; or any combination of the preceding geographical locations. In some embodiments the server farm 150 may be administered as a single entity, while in other embodiments the server farm 150 may include multiple server farms.

In some embodiments, a server farm 150 may include servers 106 that execute a substantially similar type of operating system platform (e.g., WINDOWS NT, manufactured by Microsoft Corp. of Redmond, Wash., UNIX, LINUX, or SNOW LEOPARD.) In other embodiments, the server farm 150 may include a first group of servers 106 that execute a first type of operating system platform, and a second group of servers 106 that execute a second type of operating system platform. The server farm 150, in other embodiments, may include servers 106 that execute different types of operating system platforms.

The servers 106A-N may be any server type. For example, each of servers 106A-N may be any of the following server types: a file server; an application server; a web server; a proxy server; an appliance; a network appliance; a gateway; an application gateway; a gateway server; a virtualization server; a deployment server; a SSL VPN server; a firewall; a web server; an application server or as a master application server; a server 106 executing an active directory; or a server 106 executing an application acceleration program that provides firewall functionality, application functionality, or load balancing functionality. A server 106 may be a RADIUS server that includes a remote authentication dial-in user service. In embodiments where the server 106 comprises an appliance, the server 106 may be an appliance manufactured by any one of the following manufacturers: the Citrix Application Networking Group; Silver Peak Systems, Inc; Riverbed Technology, Inc.; F5 Networks, Inc.; or Juniper Networks, Inc. Some embodiments include a first server 106A that receives requests from a client machine 102, forwards the request to a second server 106B, and responds to the request generated by the client machine 102 with a response from the second server 106B. The first server 106A may acquire an enumeration of applications available to the client machine 102 and well as address information associated with an application server 106 hosting an application identified within the enumeration of applications. The first server 106A may then present a response to the client's request using a web interface, and communicate directly with the client 102 to provide the client 102 with access to an identified application.

The server 106 may, in some embodiments, execute any one of the following applications: a thin-client application using a thin-client protocol to transmit application display data to a client; a remote display presentation application; any portion of the CITRIX ACCESS SUITE by Citrix Systems, Inc. like the XENAPP or CITRIX PRESENTATION SERVER; MICROSOFT WINDOWS Terminal Services manufactured by the Microsoft Corporation; or an ICA client, developed by Citrix Systems, Inc. Another embodiment includes a server 106 that is an application server such as: an email server that provides email services such as MICROSOFT EXCHANGE manufactured by the Microsoft Corporation; a web or Internet server; a desktop sharing server; a collaboration server; or any other type of application server. Still other embodiments include a server 106 that executes any one of the following types of hosted servers applications: GOTOMEETING provided by Citrix Online Division, Inc.; WEBEX provided by WebEx, Inc. of Santa Clara, Calif.; or Microsoft Office LIVE MEETING provided by Microsoft Corporation.

Client machines 102 may, in some embodiments, be a client node that seeks access to resources provided by a server 106. In other embodiments, the server 106 may provide clients 102 or client nodes with access to hosted resources. The server 106, in some embodiments, functions as a master node such that it communicates with one or more clients 102 or servers 106. In some embodiments, the master node may identify and provide address information associated with a server 106 hosting a requested application, to one or more clients 102 or servers 106. In still other embodiments, the master node may be a server farm 150, a client 102, a cluster of client nodes 102, or an appliance.

One or more clients 102 and/or one or more servers 106 may transmit data over a network 104 installed between machines and appliances within the computing environment 101. The network 104 may comprise one or more sub-networks, and may be installed between any combination of the clients 102, servers 106, computing machines and appliances included within the computing environment 101. In some embodiments, the network 104 may be: a local-area network (LAN); a metropolitan area network (MAN); a wide area network (WAN); a primary network 104 comprised of multiple sub-networks located between the client machines 102 and the servers 106; a primary public network 104 with a private sub-network; a primary private network 104 with a public sub-network; or a primary private network 104 with a private sub-network. Still further embodiments include a network 104 that may be any of the following network types: a point to point network; a broadcast network; a telecommunications network; a data communication network; a computer network; an ATM (Asynchronous Transfer Mode) network; a SONET (Synchronous Optical Network) network; a SDH (Synchronous Digital Hierarchy) network; a wireless network; a wireline network; or a network 104 that includes a wireless link where the wireless link may be an infrared channel or satellite band. The network topology of the network 104 may differ within different embodiments, possible network topologies include: a bus network topology; a star network topology; a ring network topology; a repeater-based network topology; or a tiered-star network topology. Additional embodiments may include a network 104 of mobile telephone networks that use a protocol to communicate among mobile devices, where the protocol may be any one of the following: AMPS; TDMA; CDMA; GSM; GPRS UMTS; EV-DO; LTE; or any other protocol able to transmit data among mobile devices like 802.11, Bluetooth, and Near Field Communication.

FIG. 1B illustrates an example of a computing device 100, where the client machine 102 and server 106 illustrated in FIG. 1A may be deployed as and/or executed on any embodiment of the computing device 100 illustrated and described herein. Included within the computing device 100 is a system bus 150 that communicates with the following components: a central processing unit 121; a main memory 122; storage/memory 128; an input/output (I/O) controller 123; display devices 124A-124N; an installation device 116; and a network interface 118. In one embodiment, the storage/memory 128 includes: an operating system, software routines, and a client agent 120. The I/O controller 123, in some embodiments, is further connected to a key board 126, and a pointing device 127. Other embodiments may include an I/O controller 123 connected to more than one input/output device 130A-130N.

FIG. 1C illustrates one embodiment of a computing device 100. The client machine 102 and server 106 illustrated in FIG. 1A may be deployed as and/or executed on any embodiment of the computing device 100 illustrated and described herein. Included within the computing device 100 is a system bus 150 that communicates with the following components: a bridge 170, and a first I/O device 130A. Bridge 170 may be in further communication with the main central processing unit 121, where the central processing unit 121 may further communicate with a second I/O device 130B, a main memory 122, and a cache memory 140. Included within the central processing unit 121, are I/O ports, a memory port 103, and a main processor.

Embodiments of the computing machine 100 may include a central processing unit 121 characterized by, for example, any one of the following component configurations: logic circuits that respond to and process instructions fetched from the main memory unit 122; a microprocessor unit, such as: those manufactured by Intel Corporation; those manufactured by Motorola Corporation; those manufactured by Transmeta Corporation of Santa Clara, Calif.; the RS/6000 processor such as those manufactured by International Business Machines; a processor such as those manufactured by Advanced Micro Devices; or any other combination of logic circuits. Still other embodiments of the central processing unit 122 may include any combination of the following: a microprocessor, a microcontroller, a central processing unit with a single processing core, a central processing unit with two processing cores, or a central processing unit with more than one processing core.

While FIG. 1C illustrates a computing device 100 that includes a single central processing unit 121, in some embodiments the computing device 100 may include one or more processing units 121. In these embodiments, the computing device 100 may store and execute firmware or other executable instructions that, when executed, direct the one or more processing units 121 to simultaneously execute instructions or to simultaneously execute instructions on a single piece of data. In other embodiments, the computing device 100 may store and execute firmware or other executable instructions that, when executed, direct the one or more processing units to each execute a section of a group of instructions. For example, each processing unit 121 may be instructed to execute a portion of a program or a particular module within a program.

In some embodiments, the processing unit 121 may include one or more processing cores. For example, the processing unit 121 may have two cores, four cores, eight cores, etc. In one embodiment, the processing unit 121 may comprise one or more parallel processing cores. The processing cores of the processing unit 121, may in some embodiments access available memory as a global address space, or in other embodiments, memory within the computing device 100 may be segmented and assigned to a particular core within the processing unit 121. In one embodiment, the one or more processing cores or processors in the computing device 100 may each access local memory. In still another embodiment, memory within the computing device 100 may be shared amongst one or more processors or processing cores, while other memory may be accessed by particular processors or subsets of processors. In embodiments where the computing device 100 includes more than one processing unit, the multiple processing units may be included in a single integrated circuit (IC). These multiple processors, in some embodiments, may be linked together by an internal high speed bus, which may be referred to as an element interconnect bus.

In embodiments where the computing device 100 includes one or more processing units 121, or a processing unit 121 including one or more processing cores, the processors may execute a single instruction simultaneously on multiple pieces of data (SIMD), or in other embodiments may execute multiple instructions simultaneously on multiple pieces of data (MIMD). In some embodiments, the computing device 100 may include any number of SIMD and MIMD processors.

The computing device 100, in some embodiments, may include a graphics processor or a graphics-processing unit (Not Shown). The graphics processing unit may include any combination of software and hardware, and may further input graphics data and graphics instructions, render a graphic from the inputted data and instructions, and output the rendered graphic. In some embodiments, the graphics processing unit may be included within the processing unit 121. In other embodiments, the computing device 100 may include one or more processing units 121, where at least one processing unit 121 is dedicated to processing and rendering graphics.

One embodiment of the computing machine 100 includes a central processing unit 121 that communicates with cache memory 140 via a secondary bus also known as a backside bus, while another embodiment of the computing machine 100 includes a central processing unit 121 that communicates with cache memory via the system bus 150. The local system bus 150 may, in some embodiments, also be used by the central processing unit to communicate with more than one type of I/O device 130A-130N. In some embodiments, the local system bus 150 may be any one of the following types of buses: a VESA VL bus; an ISA bus; an EISA bus; a MicroChannel Architecture (MCA) bus; a PCI bus; a PCI-X bus; a PCI-Express bus; an AGP bus; or a NuBus. Other embodiments of the computing machine 100 include an I/O device 130A-130N that is a video display 124 that communicates with the central processing unit 121. Still other versions of the computing machine 100 include a processor 121 connected to an I/O device 130A-130N via any one of the following connections: HyperTransport, Rapid I/O, or InfiniBand. Further embodiments of the computing machine 100 include a processor 121 that communicates with one I/O device 130A using a local interconnect bus and a second I/O device 130B using a direct connection.

The computing device 100, in some embodiments, includes a main memory unit 122 and cache memory 140. The cache memory 140 may be any memory type, and in some embodiments may be any one of the following types of memory: SRAM; BSRAM; or EDRAM. Other embodiments include cache memory 140 and a main memory unit 122 that may be any one of the following types of memory: Static random access memory (SRAM), Burst SRAM or SynchBurst SRAM (BSRAM); Dynamic random access memory (DRAM); Fast Page Mode DRAM (FPM DRAM); Enhanced DRAM (EDRAM), Extended Data Output RAM (EDO RAM); Extended Data Output DRAM (EDO DRAM); Burst Extended Data Output DRAM (BEDO DRAM); Enhanced DRAM (EDRAM); synchronous DRAM (SDRAM); JEDEC SRAM; PC100 SDRAM; Double Data Rate SDRAM (DDR SDRAM); Enhanced SDRAM (ESDRAM); SyncLink DRAM (SLDRAM); Direct Rambus DRAM (DRDRAM); Ferroelectric RAM (FRAM); Memristor based memory; or any other type of memory. Further embodiments include a central processing unit 121 that may access the main memory 122 via: a system bus 150; a memory port 103; or any other connection, bus or port that allows the processor 121 to access memory 122.

One embodiment of the computing device 100 provides support for any one of the following installation devices 116: a CD-ROM drive, a CD-R/RW drive, a DVD-ROM drive, tape drives of various formats, a USB device, Secure Digital card, NetBoot or iPXE firmware, a bootable medium, a bootable CD, a bootable CD for GNU/Linux distribution such as KNOPPIX®, a hard-drive or any other device suitable for installing applications or software. Applications may in some embodiments include a client agent 120, or any portion of a client agent 120. The computing device 100 may further include a storage device 128 that may be either one or more hard disk drives, or one or more redundant arrays of independent disks; where the storage device is configured to store an operating system, software, programs applications, or at least a portion of the client agent 120. A further embodiment of the computing device 100 includes an installation device 116 that is used as the storage device 128.

The computing device 100 may further include a network interface 118 to interface to a Local Area Network (LAN), Wide Area Network (WAN) or the Internet through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections may also be established using a variety of communication protocols (e.g., TCP/IP, IPX, SPX, NetBIOS, Ethernet, ARCNET, SONET, SDH, Fiber Distributed Data Interface (FDDI), RS232, RS485, IEEE 802.11, IEEE 802.11a, IEEE 802.11b, IEEE 802.11g, CDMA, GSM, WiMax and direct asynchronous connections). One version of the computing device 100 includes a network interface 118 able to communicate with additional computing devices 100′ via any type and/or form of gateway or tunneling protocol such as Secure Socket Layer (SSL) or Transport Layer Security (TLS), or the Citrix Gateway Protocol manufactured by Citrix Systems, Inc. Versions of the network interface 118 may comprise any one of: a built-in network adapter; a network interface card; a PCMCIA network card; a card bus network adapter; a wireless network adapter; a USB network adapter; a modem; or any other device suitable for interfacing the computing device 100 to a network capable of communicating and performing the methods and systems described herein.

Embodiments of the computing device 100 include any one of the following I/O devices 130A-130N: a keyboard 126; a pointing device 127; mice; trackpads; an optical pen; trackballs; microphones; drawing tablets; video displays; speakers; inkjet printers; laser printers; and dye-sublimation printers; or any other input/output device able to perform the methods and systems described herein. An I/O controller 123 may in some embodiments connect to multiple I/O devices 103A-130N to control the one or more I/O devices. Some embodiments of the I/O devices 130A-130N may be configured to provide storage or an installation medium 116, while others may provide a universal serial bus (USB) interface for receiving USB storage devices such as the USB Flash Drive line of devices manufactured by Twintech Industry, Inc. Still other embodiments include an I/O device 130 that may be a bridge between the system bus 150 and an external communication bus, such as: a USB bus; an Apple Desktop Bus; an RS-232 serial connection; a SCSI bus; a FireWire bus; a FireWire 800 bus; an Ethernet bus; an AppleTalk bus; a Gigabit Ethernet bus; an Asynchronous Transfer Mode bus; a HIPPI bus; a Super HIPPI bus; a SerialPlus bus; a SCI/LAMP bus; a FibreChannel bus; or a Serial Attached small computer system interface bus.

In some embodiments, the computing machine 100 may connect to multiple display devices 124A-124N, in other embodiments the computing device 100 may connect to a single display device 124, while in still other embodiments the computing device 100 connects to display devices 124A-124N that are the same type or form of display, or to display devices that are different types or forms. Embodiments of the display devices 124A-124N may be supported and enabled by the following: one or multiple I/O devices 130A-130N; the I/O controller 123; a combination of I/O device(s) 130A-130N and the I/O controller 123; any combination of hardware and software able to support a display device 124A-124N; any type and/or form of video adapter, video card, driver, and/or library to interface, communicate, connect or otherwise use the display devices 124A-124N. The computing device 100 may in some embodiments be configured to use one or multiple display devices 124A-124N, these configurations include: having multiple connectors to interface to multiple display devices 124A-124N; having multiple video adapters, with each video adapter connected to one or more of the display devices 124A-124N; having an operating system configured to support multiple displays 124A-124N; using circuits and software included within the computing device 100 to connect to and use multiple display devices 124A-124N; and executing software on the main computing device 100 and multiple secondary computing devices to enable the main computing device 100 to use a secondary computing device's display as a display device 124A-124N for the main computing device 100. Still other embodiments of the computing device 100 may include multiple display devices 124A-124N provided by multiple secondary computing devices and connected to the main computing device 100 via a network.

In some embodiments, the computing machine 100 may execute any operating system. Examples of operating systems that embodiments of computing machine 100 may execute include: versions of the MICROSOFT WINDOWS operating systems such as WINDOWS 3.x; WINDOWS 95; WINDOWS 98; WINDOWS 2000; WINDOWS NT 3.51; WINDOWS NT 4.0; WINDOWS CE; WINDOWS XP; and WINDOWS VISTA; the different releases of the Unix and Linux operating systems; any version of the MAC OS manufactured by Apple Computer; OS/2, manufactured by International Business Machines; any embedded operating system; any real-time operating system; any open source operating system; any proprietary operating system; any operating systems for mobile computing devices; or any other operating system. The computing machine 100 may execute multiple operating systems. For example, the computing machine 100 may execute PARALLELS or another virtualization platform that may execute or manage a virtual machine executing a first operating system, while the computing machine 100 executes a second operating system different from the first operating system.

The computing machine 100 may be embodied in any one of the following computing devices: a computing workstation; a desktop computer; a laptop or notebook computer; a server; a handheld computer; a mobile telephone; a portable telecommunication device; a media playing device; a gaming system; a mobile computing device; a netbook; a device of the IPOD family of devices manufactured by Apple Computer; any one of the PLAYSTATION family of devices manufactured by the Sony Corporation; any one of the Nintendo family of devices manufactured by Nintendo Co; any one of the XBOX family of devices manufactured by the Microsoft Corporation; or any other type and/or form of computing, telecommunications or media device that is capable of communication and that has sufficient processor power and memory capacity to perform the methods and systems described herein. In other embodiments the computing machine 100 may be a mobile device such as any one of the following mobile devices: a JAVA-enabled cellular telephone or personal digital assistant (PDA), such as the i55sr, i58sr, i85s, i88s, i90c, i95cl, or the im1100, all of which are manufactured by Motorola Corp; the 6035 or the 7135, manufactured by Kyocera; the i300 or i330, manufactured by Samsung Electronics Co., Ltd; the TREO 180, 270, 600, 650, 680, 700p, 700w, or 750 smart phone manufactured by Palm, Inc; any computing device that has different processors, operating systems, and input devices consistent with the device; or any other mobile computing device capable of performing the methods and systems described herein. In still other embodiments, the computing device 100 may be any one of the following mobile computing devices: any one series of Blackberry, or other handheld device manufactured by Research In Motion Limited; the iPhone manufactured by Apple Computer; Palm Pre; a Pocket PC; a Pocket PC Phone; or any other handheld mobile device.

In some embodiments, the computing device 100 may have different processors, operating systems, and input devices consistent with the device. For example, in one embodiment, the computing device 100 is a TREO 180, 270, 600, 650, 680, 700p, 700w, or 750 smart phone manufactured by Palm, Inc. In some of these embodiments, the TREO smart phone is operated under the control of the PalmOS operating system and includes a stylus input device as well as a five-way navigator device.

In other embodiments the computing device 100 is a mobile device, such as a JAVA-enabled cellular telephone or personal digital assistant (PDA), such as the i55sr, i58sr, i85s, i88s, i90c, i95cl, or the im1100, all of which are manufactured by Motorola Corp. of Schaumburg, Illinois, the 6035 or the 7135, manufactured by Kyocera of Kyoto, Japan, or the i300 or i330, manufactured by Samsung Electronics Co., Ltd., of Seoul, Korea. In some embodiments, the computing device 100 is a mobile device manufactured by Nokia of Finland, or by Sony Ericsson Mobile Communications AB of Lund, Sweden.

In still other embodiments, the computing device 100 is a Blackberry handheld or smart phone, such as the devices manufactured by Research In Motion Limited, including the Blackberry 7100 series, 8700 series, 7700 series, 7200 series, the Blackberry 7520, or the Blackberry Pearl 8100. In yet other embodiments, the computing device 100 is a smart phone, Pocket PC, Pocket PC Phone, or other handheld mobile device supporting Microsoft Windows Mobile Software. Moreover, the computing device 100 may be any workstation, desktop computer, laptop or notebook computer, server, handheld computer, mobile telephone, any other computer, or other form of computing or telecommunications device that is capable of communication and that has sufficient processor power and memory capacity to perform the operations described herein.

In some embodiments, the computing device 100 is a digital audio player. In one of these embodiments, the computing device 100 is a digital audio player such as the Apple IPOD, IPOD Touch, IPOD NANO, and IPOD SHUFFLE lines of devices, manufactured by Apple Computer of Cupertino, Calif.. In another of these embodiments, the digital audio player may function as both a portable media player and as a mass storage device. In other embodiments, the computing device 100 is a digital audio player such as the DigitalAudioPlayer Select MP3 players, manufactured by Samsung Electronics America, of Ridgefield Park, N.J., or the Motorola m500 or m25 Digital Audio Players, manufactured by Motorola Inc. of Schaumburg, Ill. In still other embodiments, the computing device 100 is a portable media player, such as the Zen Vision W, the Zen Vision series, the Zen Portable Media Center devices, or the Digital MP3 line of MP3 players, manufactured by Creative Technologies Ltd. In yet other embodiments, the computing device 100 is a portable media player or digital audio player supporting file formats including, but not limited to, MP3, WAV, M4A/AAC, WMA Protected AAC, AIFF, Audible audiobook, Apple Lossless audio file formats and .mov, .m4v, and .mp4 MPEG-4 (H.264/MPEG-4 AVC) video file formats.

In some embodiments, the computing device 100 comprises a combination of devices, such as a mobile phone combined with a digital audio player or portable media player. In one of these embodiments, the computing device 100 is a Motorola RAZR or Motorola ROKR line of combination digital audio players and mobile phones. In another of these embodiments, the computing device 100 is an iPhone smartphone, manufactured by Apple Computer of Cupertino, Calif.

Specific technologies identified above and herein are provided for illustrative purposes only, and are not intended to limit the hardware and/or software usable with aspects described herein.

### Section B: Additional Details Regarding Systems and Methods

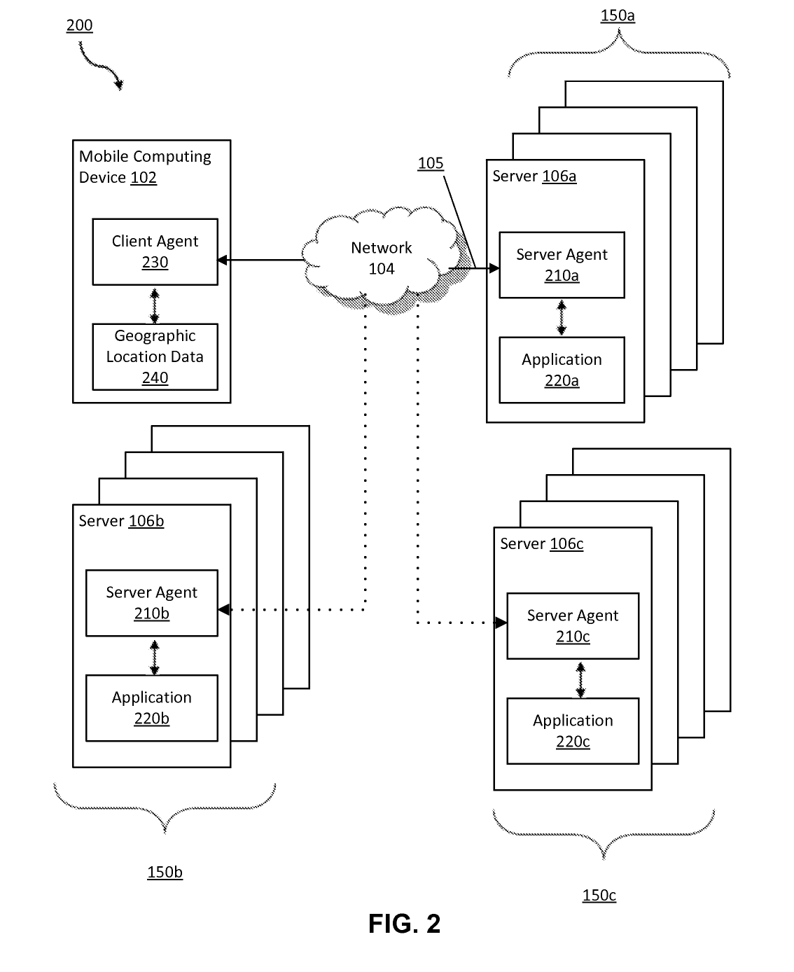

FIG. 2 illustrates a system 200 that includes mobile computing device 102 and several server farms 150a-150c to which mobile computing device 102 may connect. Each server farm includes multiple individual servers 106. As illustrated in FIG. 2, when mobile computing device 102 connects to a server farm, it may connect to a specific one of the individual servers 106, such as server 106a.

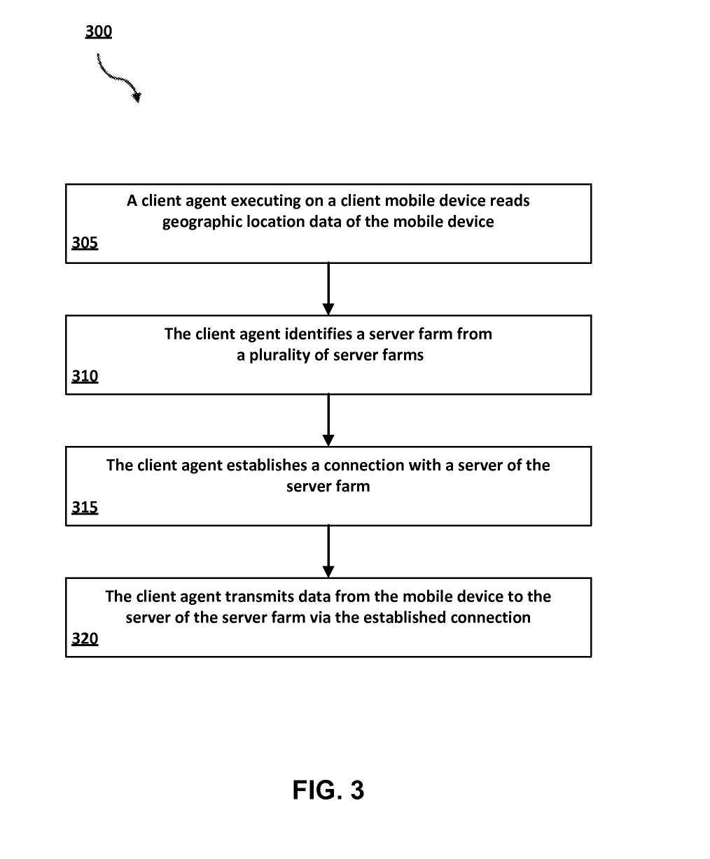

A process by which a mobile computing device may select which server and/or server farm to connect to is described below with reference to FIG. 3. First, the structure and functionality of mobile computing device 102 and server 106 will be described.

Mobile computing device 102 may be any type of computing device, such as those described in connection with FIGS. 1A-1C. For example, mobile computing device 102 may be a smart phone, tablet, and/or notebook computer. Mobile computing device 102 includes a client agent 230. Client agent 230 executes on mobile device 102 and may read geographic location data 240 of the mobile device 102. Geographic location data 240 may be communicated by client agent 230 to a server 106.

Each server 106 may be any type of computing device, such as those described in connection with Figures. 1A-1C. Mobile computing device 102 may connect to a server 106 in order to access one or more resources of server 106, such as the hardware resources (e.g. microprocessor and memory), software resources (e.g. computer applications, operating system(s), etc.), and/or data available from server 106. Each sever 106 may include server agent 210 and application 220. Sever agent 210 executes on server 106 and communicates with client agent 230. The information communicated to client agent 230 by server agent 210 may come from application 220, which also executes on server 106. Application 220 may be, for example, a hosted or virtualized application. Application 220 may comprise software, hardware, or any combination of hardware and software. In some examples, server 106 may provide a hosted or virtualized desktop, and information about the desktop, including any applications executing therein, may be communicated from server agent 210 to client agent 230.

Hosted applications and/or desktops executing on server 106 may generate sound, text, and/or graphics. The information communicated from server agent 210 of server 106 to client agent 230 may be information about how to present these elements on mobile device 102. This information may be communicated using, for example, a presentation layer protocol. For example, the Independent Computing Architecture (ICA) presentation layer protocol, or any other Open Systems Interconnection (OSI) model layer six protocol, may be used. Further examples of information that may be communicated from server 106 to client agent 230 include window creation and window process data for use in displaying a local version of a window generated on the remote server 106. Examples of information that may be communicated from mobile computing device 102 to server agent 210 of server 106 include geographic location data 240 and user inputs.

The communications between mobile computing device 102 and server 106 may occur over one or more connections. Further, each connection may be multiplexed into one or more virtual channels. A virtual channel may be, for example, a bi-directional, error-free connection. Such multiplexing may allow for different virtual channels to have different bandwidth limits or different priorities, while still being part of a single transport layer connection. This may reduce the transport layer overhead required and provide for SSL or VPN tunnel capability, while still allowing per-channel compression, buffering, and management of communication priority between the server agent 210 and the client agent 230. In some embodiments, virtual channels may be dedicated to specific content types or purposes. For example, individual virtual channels may be dedicated to, for example, sound, graphics, drive mappings, printings, etc. Virtual channels for output data, such as audio and video stream data, may be given a high priority while virtual channels for items such as window attribute data, references to application tasks, user content, preferences, etc., may be given a low priority. In some embodiments, virtual channels may be opened or closed without needing to disestablish or reestablish the transport layer connection over which they communicate.

Each of server agent 210 and client agent 230 may be part of a presentation layer protocol agent. Alternatively, each of these agents may send and receive data through a presentation layer protocol agent. Each of server agent 210 and client agent 230 may be implemented in software, hardware, or any combination of hardware and software. Each of server agent 210 and client agent 230 may include a module for receiving data. The receiver module may be provided as, for example, a dynamically linked library component

Client agent 230 may transmit geographic location data 240 of mobile computing device 102 to server 106. Geographic location data 240 may be any type of data that describes the geographic location of mobile computing device 102. One example of geographic location data 240 is latitude and longitude coordinates, as calculated by, for example, a GPS system of mobile computing device 102. A variety of types of GPS systems exist, including standalone GPS receivers and assisted GPS receivers, which rely on outside devices, such as cellular towers and/or networked servers. The networked servers may be reached via, for example a WiFi connection and/or a cellular connection, including 3G and 4G data connections. Additional examples of geographic location data 240 include information that may be used to calculate an exact or approximate latitude and longitude of mobile computing device 102. This may include data received from a GPS receiver of mobile computing device 102, information relating to networks near mobile computing device 102 (e.g. identifiers and/or characteristics of WiFi networks that are in range of mobile device 102, identifiers and/or characteristics of cellular telephone/data towers that are in range of mobile device 102, etc); or any other data that may be used to identify the geographic location of mobile computing device 102.

The geographic location data 240 may be used by applications executing on server 106. These applications may include hosted or virtualized applications that display on mobile computing device 102, as discussed above. An application 220 may use geographic location data 240 to determine a dataset to use when executing. For example, if a user opens an application for sales figures that executes on server 106, the application may identify the relevant dataset responsive to the geographic location data 240. If a user is in Japan and launches the sales figure application, the server will use the geographic location data 240 of the mobile device to load the data for Japan. If the same user opens the same sales figure application in England, the server 106 will use the geographic location data 240 of the mobile device to load the data for England.

An application 220 executing on server 106 may use the geographic location data 240 of the mobile device 102 to emulate an application executing locally on mobile device 102. This may allow the application 220 to provide the user with relevant information in accordance with the user's geographic location. For instance, the application may update any calendar events to local time responsive to the geographic location data, rather than displaying the calendar events using the time and date of the server. Another example is a mapping application. The application may display a map that is centered on the user's current location, as indicated by geographic location data 240, as opposed to centering the map on the location of server 106.

FIG. 3 illustrates a method 300 for establishing a connection to server 106 responsive to geographic location data 240 of a mobile device 102. In brief overview, at step 305 a client agent 230 executing on a mobile device 102 reads geographic location data 240 of the mobile device 102. At step 310, the client agent 230 identifies a server farm 150 from a plurality of server farms to connect with the mobile device 102. At step 315, the client agent 230 establishes a connection with a server 106 of the server farm 150. At step 320, the client agent 230 transmits data 240 from the mobile device 102 to the server 106 of the server farm 150 via the established connection.

Now referring FIG. 3, and in more detail, at step 305 a client agent 230 executing on a mobile device 102 reads geographic location data 240 of the mobile device 102. The client agent 230 may read geographic location data 240 that is already stored on the device. The client agent 230 may also a retrieve geographic location data 240 by calling a module that returns geographic location data. Some modules that return geographic location data may calculate the geographic location data upon being called, thereby ensuring that the geographic location data is up-to-date. Other modules that return geographic location data may return the most-recently calculated geographic location data without calculating it anew. One or more modules that return geographic location data may be programmatically accessed through, for example, a library provided by the mobile device.

At step 310, the client agent 230 identifies a server farm 150a from a plurality of server farms 150a-150c to connect with the mobile device 102. At step 315, the client agent 230 establishes a connection with a server (e.g. 106a) of the identified server farm (e.g. 150a). The connection may be, for example, a presentation layer protocol connection. Other types of connections may also be used. For example, binary data may be exchanged over a lower-layer connection.

In some instances, more than one server and/or server farm may be identified. Which servers and/or server farms are identified may be governed by one or more policies of the mobile computing device 102. The policies may be specified by a user of the mobile computing device, by an administrator of the mobile computing device, or a combination thereof Administrative policies may restrict the policies that may be specified by a user of the mobile device.

The policies, as specified by an administrator, a user, or a combination thereof, may specify, for example, that a server farm is to be selected from the plurality of server farms based on the geographic location data 240 of the mobile device 102. For example, the server farm or farms that are physically located nearest to the location indicated by geographic location data 240 may be selected.

The policies may also reflect additional criteria. For example, only server farms, or servers within server farms, that have certain applications available may be selected. For example, only servers or server farms on which Microsoft Word is available may be identified by client agent 230. The one or more applications that may be required to be available from a server or server farm may be a static requirement of the policies used by client agent 230. Alternatively, some or all of the applications that may be required to be available may be a dynamic requirement. For example, a connection to a server farm may be initiated upon a user beginning a certain type of application, such as a spreadsheet application. Given this context, the server(s) that are identified may be required to have the spreadsheet application available. However, if a connection to a server farm is initiated upon a user beginning a different application or under a different circumstance, the server(s) that are identified might not be required to have the spreadsheet application available.

Another example of a criterion that may define the policies used by client agent 230 is the default localization of the server. For instance, an English speaking user traveling to Japan may connect to a server that is localized to English rather than Japanese.

Access to certain servers and/or server farms may be restricted based on user permissions. User permissions may be determined based on a user identity (as established, for example, by a user ID and password, a cryptographic key, etc.) and/or by an identifier of mobile computing device 102. For example, a user with a low level of security clearance may not be able to access a server that another user can access. Thus, user permissions are another example of a criterion that may be used to select servers and/or server farms. User permissions may differ within a server as well as across servers. For example, users with greater permissions may be able to see certain applications that other users with lesser permissions cannot see. Similarly, the data available to each user may vary depending on each the user's permissions.

In some embodiments, a user may only connect to certain servers while in the geographic region in which the server resides. For instance, a user may connect to certain Japanese servers while in Japan, but might not be able to access these servers from any other country.

A further example of a criterion that a policy may use when selecting servers or server farms is input from a load balancer. A load balancer may direct connection requests to a particular server or server farm in order to ensure that each server and/or server farm has sufficient processing capacity.

Any combination of criteria may be used when determining which servers and/or server farms to identify and/or connect to. For example, the geographically nearest server farm that both has an application available and is localized to a certain language may be identified. Another example is that geographic location data 240 may be ignored, and a predetermined server and/or server farm may be identified. This may occur, for example, if a user disables use of geographic location data 240 or if the data is unavailable for another reason. A predetermined server and/or server farm may also be used even if geographic location data 240 is not being ignored.

Client agent 230 may also connect to a predetermined server as part of the process of selecting a server and/or server farm. A predetermined server may be identified by, for example, an IP address. The identity of the predetermined server may be specified by a user, by an administrator, or by a manufacturer of mobile computing device 102.

In some embodiments, a predetermined server may execute policies and select a server and/or server farm with which client agent 230 will ultimately connect. The policies may be stored at the predetermined server, or they may be communicated to the predetermined server from mobile computing device 102. A predetermined server may return to mobile computing device 102 an identification of one or more servers and/or server farms that are identified by the policies. Alternatively, or in additional, a predetermined server may return a ranking of servers and/or server farms to mobile computing device. Finally, a predetermined server may return information about servers and/or server farms that mobile computing device 102 may use to execute the policies itself.

A predetermined server may facilitate a connection with the servers and/or server farms identified as a result of executing the policies. One example of a predetermined server is a load balancer, which may re-direct the connection from mobile device 102 to an additional server, such as server 106a illustrated in FIG. 2.

Mobile computing device 102 may have one or more sets of policies associated with a user. The user may choose which set of policies to use at each connection. Further, a default policy or set of policies may control in the absence of a user selection. Each policy may be stored on the mobile device 102. For example, the policies may be stored in a table, database, or other data storage. Alternatively, or in addition, the policies may be stored on a separate server 106 accessible by the mobile device 102. For example, the policies may be stored in a database stored in a central location that is accessible by mobile device 102.

In some embodiments, the client agent 230 identifies a plurality of servers and/or server farms to connect with the mobile device 102. This may occur where more than one server and/or server farm is needed or desired in order to perform a task. Alternatively, or in addition, a plurality of identified servers and/or server farms may be displayed to the user so that the user may select from them.

The client agent 230 may establish a connection with a second server farm (e.g. 150b) responsive to a failed connection attempt with a server (e.g. 106a) of the first server farm (e.g. 150a). The client agent 230 may re-establish the connection with the server (e.g. 106a) of the first server farm (e.g. 150a). This may occur responsive to an interrupted connection with the second server form (e.g. 150b), in response to the first server farm (e.g. 150a) becoming available again, in response to a user request, etc. If a connection established by the mobile device fails, then the location data 240 may be used to identify the next nearest server 106 that is available and responsive.

At step 320, the client agent 230 transmits data 240 from the mobile device 102 to the identified server (e.g. 106a) via the established connection. The data may include geographic location data 240. Geographic location data 240 may be stored on the server (e.g. 106a). Alternatively, or in addition, geographic location data 240 may be stored in a centralized database accessible to the server (e.g. 106a). The centralized database may be, but is not required to be, a part of the servers or server farms to which mobile computing device may connect (e.g. farms 150a-c). In some embodiments, the geographic location data 240 is stored on a central server that may be accessed by any of the servers in any of the server farms 150a-150c.

While certain exemplary aspects and embodiments have been described and shown in the above description and accompanying drawings, it is to be understood that such embodiments are merely illustrative of and not restrictive on the methods and systems described herein. Further, it is to be understood that various aspects and features for the disclosure may be combined in any combination. Additionally, it is possible to implement the methods and systems described herein or some of its features in hardware, programmable devices, firmware, software or a combination thereof. The methods and systems described herein or parts of the methods and systems described herein may also be embodied in a processor-readable storage medium or machine-readable medium such as a magnetic (e.g., hard drive, floppy drive), optical (e.g., compact disk, digital versatile disk, etc.), or semiconductor storage medium (volatile and non-volatile).

1. A method comprising:
(a) reading, by a client agent executing on a mobile device, geographic location data of the mobile device;
(b) selecting, by the client agent, a server farm from a plurality of server farms based on the geographic location data of the mobile device;
(c) establishing, by the client agent, a presentation layer protocol connection with a server of the selected server farm; and
(d) transmitting, by the client agent, data from the mobile device to the server of the selected server farm via the presentation layer protocol connection.

2. The method of claim 1, wherein the selected server farm is selected by identifying which server farm of the plurality of server farms is geographically nearest to the mobile device.

3. The method of claim 1, wherein the selected server farm is selected from the plurality of server farms based on the selected server farm matching criteria identified by a user.

4. The method of claim 3, wherein the criteria identified by the user includes that one or more applications are available on said server of the selected server farm.

5. The method of claim 3, wherein the criteria identified by the user includes a server default localization.

6. The method of claim 1, further comprising selecting, by the client agent, two or more server farms from the plurality of server farms to connect with the mobile device.

7. The method of claim 1, further comprising establishing, by the client agent, a connection with a second server of the selected server farm responsive to a failed connection attempt with the server of the selected server farm.

8. The method of claim 1, further comprising establishing, by the client agent, a connection with a predetermined server and using information exchanged with the predetermined server to select said selected server farm from the plurality of server farms.

9. The method of claim 1, further comprising transmitting, by the client agent, the geographic location data of the mobile device to the server of the selected server farm.

10. The method of claim 1, further comprising re-establishing, by the client agent, the connection with the server of the selected server farm responsive to an interrupted connection.

11. A system comprising:
a mobile device that includes at least one processor and at least one memory;
wherein the memory includes instructions that configure the mobile device to:
read geographic location data of the mobile device;
select a server farm from a plurality of server farms based on the geographic location data of the mobile device;
establish a presentation layer protocol connection with a server of the selected server farm; and
transmit data from the mobile device to the server of the selected server farm via the presentation layer protocol connection.

12. The system of claim 11, wherein the instructions further configure the mobile device to:
select the selected server farm by identifying which server farm of the plurality of server farms that is geographically nearest to the mobile device.

13. The system of claim 11, wherein the instructions further configure the mobile device to:
select the selected server farm from the plurality of server farms based on the selected server farm matching criteria identified by a user.

14. The system of claim 13, wherein the criteria identified by the user includes that one or more applications are available on said server of the selected server farm.

15. The system of claim 13, wherein the criteria identified by the user includes a default localization of said server of the selected server farm.

16. The system of claim 11, wherein the instructions further configure the mobile device to:
select two or more server farms from the plurality of server farms to connect with the mobile device.

17. The system of claim 11, wherein the instructions further configure the mobile device to:
establish a connection with a second server of the selected server farm responsive to a failed connection attempt with the server of the selected server farm.

18. The system of claim 11, wherein the instructions further configure the mobile device to:
establish a connection with a predetermined server and use information exchanged with the predetermined server to select said selected server farm from the plurality of server farms.

19. The system of claim 11, wherein the instructions further configure the mobile device to:
transmit the geographic location data of the mobile device to the server.

20. The system of claim 11, wherein the instructions further configure the mobile device to:
re-establish the connection with the server of the selected server farm responsive to an interrupted connection.
